(19) United States
(12) Patent Application Publication
(10) Pub. No.: US 2009/0143010 A1
(43) Pub. Date: Jun. 4, 2009

(54) COMMUNICATION SYSTEM AND COMMUNICATION APPARATUS

(75) Inventors: Kunio Fukuda, Tokyo (JP); Kazuji Sasaki, Kanagawa (JP); Takehiro Sugita, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/270,034

(22) Filed: Nov. 13, 2008

(30) Foreign Application Priority Data
Nov. 29, 2007 (JP) 2007-308300

(51) Int. Cl. H04B 5/00

(52) U.S. Cl. 455/41.1

(57) ABSTRACT

A communication system is disclosed which includes: at least one power line communication device configured to be connected with another power line communication device via a common power line for providing a commercial alternate-current power supply; and a communication terminal configured to include a modem for power line communication and a coil for exchanging power line communication signals with an external entity through electromagnetic coupling, the communication terminal sending and receiving the signals to and from the external entity through electromagnetic coupling between the coil and the power line.

### CROSS REFERENCES TO RELATED APPLICATIONS

The present application claims priority to Japanese Patent Application JP 2007-308300 filed in the Japan Patent Office on Nov. 29, 2007, the entire contents of which is being incorporated herein by reference.

### BACKGROUND

The present application relates to a communication system and a communication apparatus for conducting power line communication when connected to household outlets. More particularly, the present application relates to a communication system and a communication apparatus for allowing mobile devices such as personal digital assistants (PDAs) and cellular phones operating without using a commercial alternate current (AC) power supply to carry out power line communication therebetween.

Recent years have witnessed the commercialization of power line communication (PLC) as convenient means to set up a local area network (LAN) in private houses or like situations. According to the PLC scheme, devices which are powered by power lines and which have a PLC capability can multiplex their communication signals on the power lines for communication with other devices having the same capability.

Wireless LAN has gained widespread acceptance as simple means to establish a LAN. Under radio law, this scheme has been subject to limited levels of transmission output to avoid interference with other radio systems and related devices. That means the wireless LAN setup has difficulty in bringing its radio waves to the configured devices across walls under the same roof. On the other hand, the PLC setup uses the existing power lines to permit communication between the connected devices in separate rooms as long as the devices are plugged into electrical outlets on the walls. The PLC scheme thus makes it possible to implement a LAN for high-speed communication at transmission rates of at least 100 Mbps without establishing an Ethernet (registered trademark) inside the building.

FIG. 8 is a schematic view showing an ordinary home network system based on PLC. In FIG. 8, reference numeral 100 denotes a household power line. Reference numerals 101 and 106 stand for household electrical outlets; 102 and 107 for AC plugs; and 103 and 108 for PLC modems (PLC modem 103 acts as the master device). Reference numeral 109 stands for a host such as a personal computer (PC); 104 for an optical line terminal device; and 105 for the Internet. The optical line terminal device 104 may be replaced by an asymmetric digital subscriber line (ADSL) modem.

The PLC modems 103 and 108 communicate with each other via the power line 100. This allows the PC 109 to connect to the Internet 104 by way of the optical line terminal device 104.

Systems have been proposed (such as one disclosed by Japanese Patent Laid-Open No. 2005-143026) which monitor and control household equipment using PLC. This type of system involves providing home-bound devices including household electrical appliances with PLC capabilities, getting a master device (e.g., PC) to monitor and control the connected devices, and allowing the master device to be further accessed from the outside via a public communication network for such monitoring and control operations.

Since PLC involves the use of power lines as transmission channels, the network configuration utilizing the existing power line layout is based on the so-called bus topology. That is, all communication devices connected by PLC to the household power lines share a bandwidth on a time-sharing basis. Whereas the typical system configuration shown in FIG. 8 has two PLC modems, a plurality of PLC modems may be configured for communication therebetween.

As shown in FIG. 8, the ordinary power line communication system basically utilizes a commercial AC power supply such as a desktop PC as its primary drive source. The system is then used by the connected devices each furnished with an AC plug capable of plugging into an AC outlet. In other words, mobile devices such as PDAs and cellular phones operating off batteries are incapable of communicating with one another by PLC. In such cases, each mobile device equipped with a wireless LAN capability needs to be connected to the PLC system via an access point, or needs to plug into an AC outlet by way of a PLC modem or an AC adapter. Such a roundabout practice can turn out to be quite inconvenient.

### SUMMARY

The present application has been made in view of the above circumstances and provides a communication system and a communication apparatus for advantageously conducting power line communication when connected to commercial AC electrical outlets. The present application also relates to providing a communication system and a communication apparatus for allowing mobile devices such as PDAs and cellular phones not utilizing a commercial AC power supply to conduct power line communication therebetween.

In an embodiment, there is provided a communication system including: at least one power line communication device configured to be connected with another power line communication device via a common power line for providing a commercial alternate-current power supply; and a communication terminal configured to include a modem for power line communication and a coil for exchanging power line communication signals with an external entity through electromagnetic coupling, the communication terminal sending and receiving the signals to and from the external entity through electromagnetic coupling between the coil and the power line.

In this specification, the term “system” refers to a logical configuration of a plurality of component devices or functional modules configured to implement specific functions. Each of the devices or functional modules may or may not be housed in a single enclosure.

According to another embodiment, there is provided a communication system including: at least one power line communication device configured to be connected with another power line communication device via a common power line for providing a commercial alternate-current power supply; a communication terminal configured to include a modem for power line communication and a first coil for exchanging power line communication signals with an external entity through electromagnetic coupling; and a coupling device configured to be connected with the power line and include a filter for attenuating alternate-current components on the power line and a second coil installed upstream of the filter; wherein the communication terminal conducts proximity communication with another communication terminal using the magnetic coupling effect occurring between the first and the second coils in the proximity of the coupling device.

According to a further embodiment, there is provided a communication system including: a plurality of communication terminals each configured to include a modem for power line communication and a first coil for exchanging power line communication signals with an external entity through electromagnetic coupling; and a coupling device configured to be connected with a power line and include a plurality of second coils laid out in a two-dimensional array connected to the power line via a filter for attenuating alternate-current components on the power line; wherein the plurality of communication terminals conduct proximity communication with one another using the magnetic coupling effect occurring between each of the first coils and each of the second coils in the proximity of the coupling device.

According to further embodiment, there is provided a communication system including: a first and a second communication apparatus each configured to include a modem for power line communication and a coil for exchanging power line communication signals with an external entity through electromagnetic coupling; wherein the first and the second communication apparatuses conduct proximity communication with each other using the electromagnetic coupling effect occurring when the coil of the first communication apparatus is placed in proximity to the coil of the second communication apparatus in such a manner that the coils are opposed to each other.

The power line communication technology has been commercialized as means to set up a LAN easily inside the household or other buildings. The devices connected to the network can communicate with one another when plugged into AC outlets on the walls of separate rooms. High-speed communications at 100 Mbps or higher are made available between the configured devices.

Basically, the traditional power line communication system uses as its principal drive source a commercial AC power supply such as a desktop PC, and includes devices with AC plugs capable of plugging into AC outlets. It follows that mobile devices including PDAs and cellular phones with no means to tap the commercial AC power supply have difficulty in connecting to the PLC system.

By contrast, the communication system has each of the configured mobile devices furnished with a modem for power line communication and a coil for exchanging power line communication signals with an external entity through electromagnetic coupling. The coil of such a mobile device receives leakage signals from the power line of some other PLC device for communication with the opposite party by use of the electromagnetic coupling effect occurring between the coil and the power line.

Alternatively, a coupling device may be connected to the power line, the device including a filter for attenuating AC components on the power line and a coil installed downstream of the filter to permit electromagnetic coupling with the coil of a mobile device. In the proximity of the coupling device, the mobile device can take part in the power line communication setup through proximity communication with the coupling device.

The coupling device is simply structured with a filter and a coil downstream thereof. The coil may be in the form of an electromagnetic coupling sheet made up of a plurality of coils arranged in a two-dimensional array.

Mobile devices may each be equipped with a modem for power line communication and a coil for exchanging power line communication signals with an external entity through electromagnetic coupling. Such mobile devices may conduct proximity communication with one another directly by having their coils positioned opposite to one another, without recourse to power line communication channels.

The present application, as outlined above, provides a communication system and a communication apparatus for ensuring power line communication advantageously when connected to common AC outlets.

According to an embodiment, mobile devices including PDAs and cellular phones can directly participate in a PLC network. Such mobile devices can then communicate with external entities through PLC in places not reached by wireless LAN signals.

The coupling device, as outlined above, is simply structured with the filter and the coil downstream thereof. The coil may be in the form of an electromagnetic coupling sheet made up of a plurality of coils arranged in a two-dimensional array. In this setup, the communicable area is in the proximity of the surface of the electromagnetic coupling sheet. With its communicable area much more limited than that of wireless LANs, the coupling device runs little danger of getting eavesdropped and provides enhanced levels of security. When a plurality of mobile devices each equipped with the PLC modem and coil are placed on the electromagnetic coupling sheet, the sheet allows the devices to communicate with one another.

Each mobile device furnished with the PLC modem and coil can communicate with its opposite party when its coil picks up leakage signals from the power line of another PLC device. Signal exchanges based on the electromagnetic coupling effect between the coil and the power line permit communication without the intervention of the coupling device such as the electromagnetic coupling sheet. This arrangement makes it possible for mobile devices to conduct communication in diverse locations.

Additional features and advantages are described herein, and will be apparent from the following Detailed Description and the figures.

### BRIEF DESCRIPTION OF THE FIGURES

FIG. 1 is a schematic view showing a typical configuration of a home network system practiced according to an embodiment;

FIG. 2 is a schematic view showing an internal structure of an electromagnetic coupling sheet;

FIG. 3 is a block diagram showing an internal structure of a PLC modem;

FIG. 4 is a block diagram showing an internal structure of a PDA;

FIG. 5 is a schematic view depicting steps to be taken by PLC modems for communication;

FIG. 6 is a schematic view showing a setup where a PDA conducts communication using leakage power from a power line without recourse to a dedicated electromagnetic coupling sheet;

FIG. 7 is a schematic view showing how mobile devices communicate with each other without the intervention of power line communication channels; and

FIG. 8 is a schematic view showing a traditional home network system based on PLC.

### DETAILED DESCRIPTION

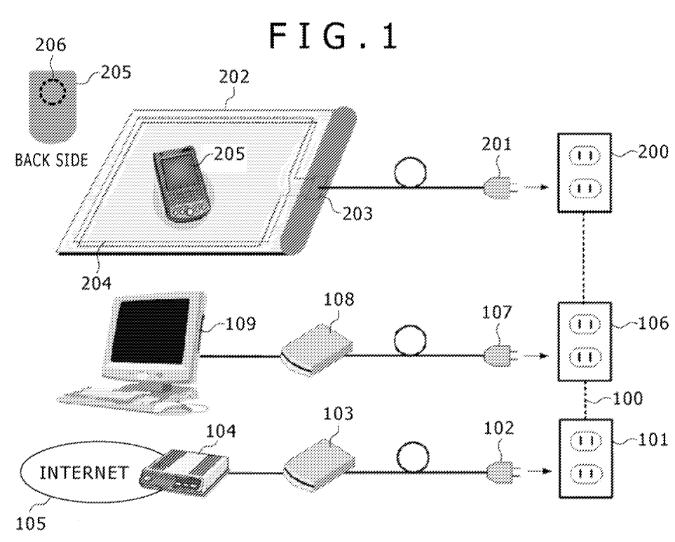

An embodiment of the present application will now be described in detail with reference to the accompanying drawings. FIG. 1 schematically shows a typical configuration of a home network system according to embodiment.

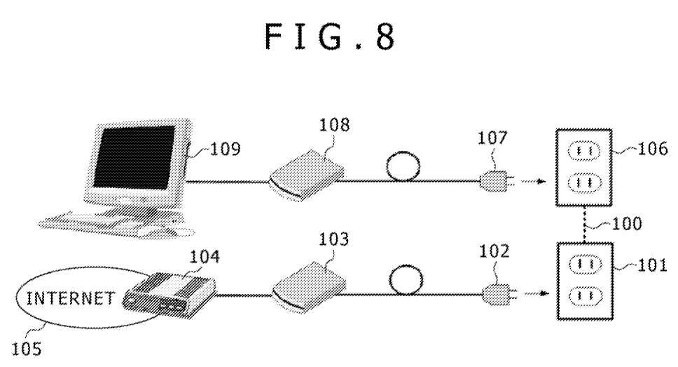

The system in FIG. 1 and the system in FIG. 8 are similar as follows. For example, a power line 100 is assumed to be installed in the household. An AC plug 107 at the tip of the power cable of a PLC modem 108 attached to a personal computer 109 is connected to a home AC outlet 106. The connection allows the personal computer 109 to take part in the home PLC network. An AC plug 102 at the tip of the power cable of an optical line terminal device (or an ADSL modem) 104 is plugged into a home AC outlet 101. The latter connection allows the home PLC network to connect with the Internet 105.

A difference between the system of FIG. 1 and the system of FIG. 8 is that a PDA 205 has joined the PLC network as a communication device taking part in the system as embodied in FIG. 1.

Since the PDA 205 does not operate on commercial AC power, it cannot have its putative AC plug connected to an AC outlet in order to participate in the PLC network. Instead, the PDA 205 includes a PLC modem and a coil for sending and receiving signals through electromagnetic coupling (to be discussed later). An electromagnetic coupling sheet 202 provides an environment of electromagnetic coupling which allows the PDA 205 to become part of the PLC network. The electromagnetic coupling sheet 202 includes a filter for attenuating AC components on the power line and a coil connected downstream of the filter for electromagnetic coupling purposes (to be discussed later). When the coil inside the PDA 205 is placed in the proximity of the coil in the sheet 202, the electromagnetic coupling effect occurs between the coils allowing the PDA 205 to send and receive PLC signals. The band for use in power line communication ranges typically from 2 to 30 MHz. A wideband setup covering that frequency band for electromagnetic coupling is demanded.

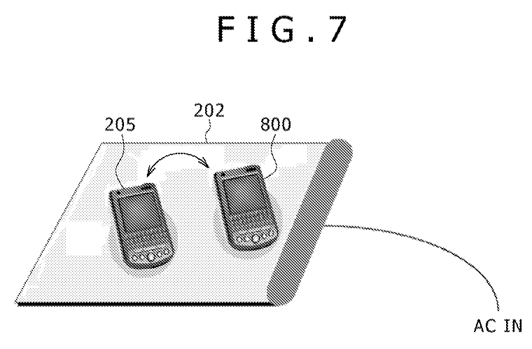

The PDA 205 is used placed on the electromagnetic coupling sheet 202. A plurality of mobile devices may be placed on the electromagnetic coupling sheet 202 depending on the latter's size. Each of these mobile devices may then communicate with another PLC modem. It is also possible for these mobile devices to communicate with one another when placed on the electromagnetic coupling sheet 202 (to be discussed later; see FIG. 7).

The electromagnetic sheet 202 is made up of a high-pass filter (HPF) 203 for cutting (or attenuating) AC components (50 to 60 Hz) from the AC line, and a coil 204 for effecting electromagnetic induction with the coil of a mobile device.

By way of the electromagnetic coupling sheet 202, power line 100, and PLC modems 103 and 108, the PDA 205 as a mobile device can thus conduct communication using PLC signals. It is also possible for the PDA 205 to connect to the Internet 105 via the optical line terminal device 104 or to communicate with the personal computer 109 participating in the PLC network.

Although the foregoing description showed the mobile device and the electromagnetic coupling sheet to be connected with one another through a magnetic field occurring therebetween, an electric field is also considered to play a significant role in the connection. Thus the scope of the present application is not limited by the effect of electromagnetic coupling.

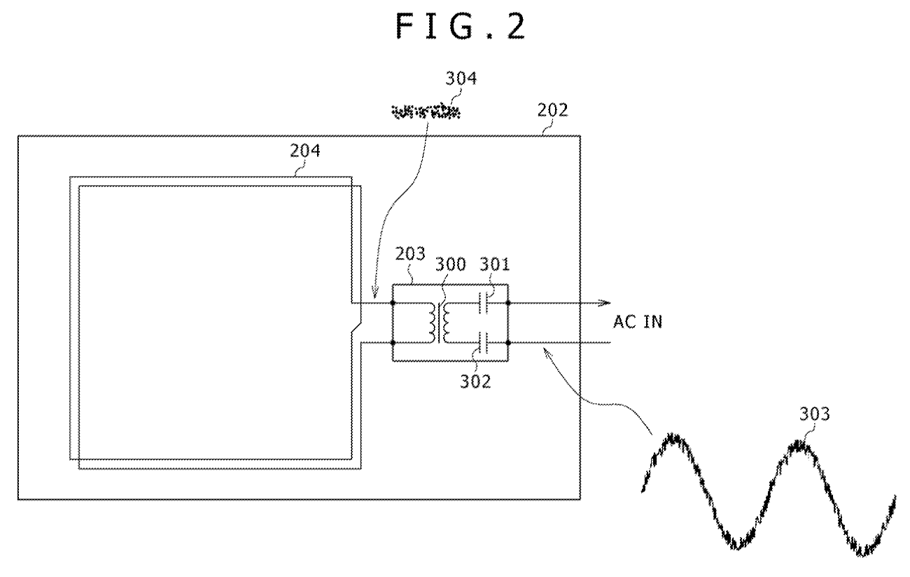

FIG. 2 schematically shows an internal structure of the electromagnetic coupling sheet 202. Reference numeral 203 represents a high-pass filter and 204 denotes for a coil. The high-pass filter 203 is constituted by a power transformer 300 and two capacitors 301 and 302. These components form a balanced input/output high-pass filter. The terminals of the capacitors 301 and 302 are connected to the power line 100.

Orthogonal frequency division multiplex (OFDM) is utilized extensively as the modulation method for PLC. Under the OFDM modulation method, the frequencies of different carriers are established in such a manner that their subcarriers will be orthogonal to one another within each symbolic interval. The subcarriers being orthogonal to one another signify that the spectrum peak point of a given subcarrier coincides invariably with that of another subcarrier so that no cross talk occurs even if the bands of adjacent subcarriers are close enough to overlap with one another. Because outgoing data is distributed among a plurality of carriers with their frequencies orthogonal to one another, each carrier is assigned a narrowband. This method provides very high levels of efficiency in frequency utilization.

Reference numeral 303 in FIG. 2 denotes a waveform of a PLC signal sent over the power line 100. It will be appreciated that an OFDM signal is multiplexed onto the AC signal. When the PLC signal passes through the high-pass filter 203, the AC components of 50 to 60 Hz are removed from the signal. The result is an AC component-free OFDM signal indicated by reference numeral 304. The OFDM signal from the electromagnetic coupling sheet 202 (i.e., outgoing signal from a PDA 20) moves in the reverse direction: when passing through the high-pass filter 203, the OFDM signal is multiplexed onto the AC signal for transmission to the opposite PLC modem in communication.

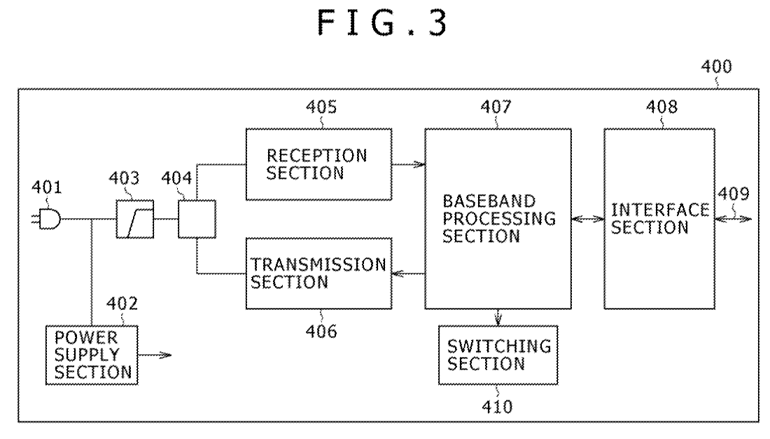

FIG. 3 shows an internal structure of a PLC modem 400. The PLC modem 400 is representative of the PLC modems 103 and 108 in FIG. 1. Reference numeral 401 stands for an AC plug; 402 for a power supply section that rectifies AC power to DC power; 403 for a high-pass filter; 404 for a coupling section that couples outgoing waves with incoming waves; 405 for a reception section; 406 for a transmission section; 407 for a baseband processing section that modulates and demodulates the OFDM signal while effecting communication control; and 408 for an interface section that carries out interfacing processes such as those of the Ethernet (registered trademark).

The PLC signal received by the AC plug 401 is sent to the high-pass filter 403 whereby the AC components of 50 to 60 Hz are removed from the signal. The filtered PLC signal is then forward through the coupling section 404 to the reception section 405 for amplification. The amplified signal from the reception section 405 is sent to the baseband processing section 407. The baseband processing section 407 subjects the received signal to analog/digital (A/D) conversion followed by OFDM demodulation for conversion of the signal into digital data.

Data coming over the Ethernet (registered trademark) is forwarded through the interface section 408 to the baseband processing section 407 for OFDM modulation and digital/analog (D/A) conversion. Having undergone the processing by the baseband processing section 407, the data becomes a PLC signal that is passed on to the transmission section 406. The PLC signal is amplified by the transmission section 406 before being multiplexed onto an AC power signal by way of the coupling section 404 and high-pass filter 403. The multiplexed signal is sent onto the power line 100 through the AC plug 401.

The baseband processing section 407 also performs machine access control (MAC) processes including framing, de-framing, error correction, and retransmission.

At the PLC modem 400, a master-slave changeover is needed. A switching section designated by reference numeral 410 allows the user manually to switch between the master and the slave settings. The PLC modem acting as the master station transmits beacon signals intermittently. Each PLC modem serving as a slave station checks the beam signals to determine the availability of communication and other kinds of information. The master station is valid in the case where Qos (quality of service) is demanded. Where a plurality of PLC modems are interconnected in an autonomous distributed control setup, there is no need for defining the master-slave relationship therebetween.

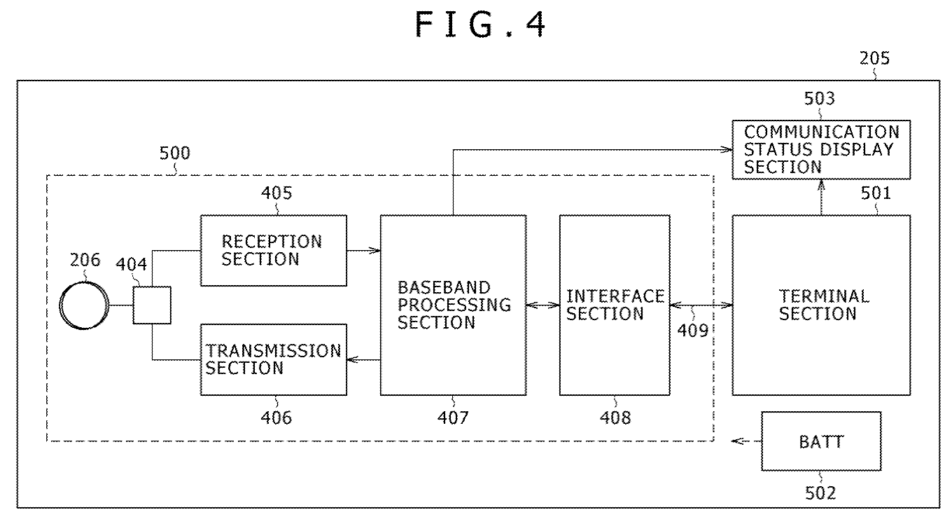

FIG. 4 shows an internal structure of the PDA 205. In FIG. 4, reference numeral 500 denotes a PLC modem section. The PLC modem section 500 may be in the form of either a built-in module or a detachable card such as a compact flash card.

Reference numeral 206 represents a coil for effecting electromagnetic coupling with the coil 204 of the electromagnetic coupling sheet 202. Reference numeral 501 denotes a terminal section 501 (i.e., body of the PDA). The structure of the PDA body is not relevant to the scope of the present application and thus will not be discussed further. The PLC modem section 500 is interfaced with the terminal section 501 through a bus connection if the PLC modem section 500 is a built-in section or through the use of a compact flash interface if the PLC modem section 500 is a detachable card. Reference numeral 502 represents a battery section and 503 represents a communication status display section by LED or the like.

The PLC signal received by the coil 206 is sent through the coupling section 404 to the reception section 405 for amplification. The amplified PLC signal is forwarded to the baseband processing section 407 for A/D conversion followed by OFDM demodulation, whereby the PLC signal is converted to digital data.

Data coming from the terminal section 501 passes through the interface section 408 to reach the baseband processing section 407 for OFDM modulation and D/A conversion. The processing by the baseband processing section 407 turns the data into a PLC signal that is sent to the transmission section 406 for amplification. The PLC signal amplified by the transmission section 406 is forwarded through the coupling section 404 to the coil 206. The coil 206 transmits the PLC signal in the form of electromagnetic waves to the coil 204 of the electromagnetic coupling sheet 202.

The baseband processing section 407, as mentioned above, further performs MAC processes including framing, de-framing, error correction, and retransmission. The communication status display section 503 is provided to inform the user of ongoing communication status using different color indications and blinking frequencies in a manner reflecting the level of reception, the number of successfully received packets, and other conditions.

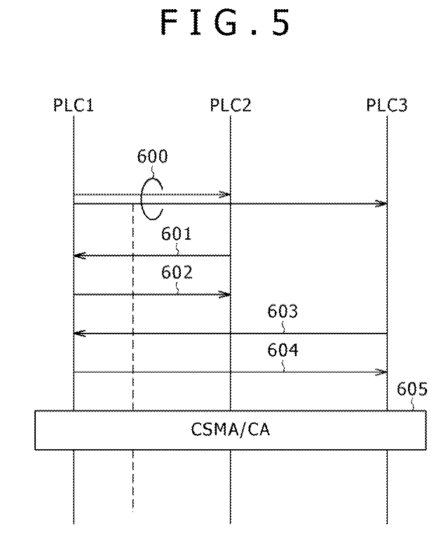

FIG. 5 schematically depicts typical steps to be taken by PLC modems for communication. In the communication procedure of FIG. 5, the master-slave relationships are assumed to be established among the PLC modems. Specifically, it is assumed that the PLC modem 1 acts as the master and that the PLC modems 2 and 3 serve as slaves, each of the latter being representative of the PDA 205.

The PLC modem 1 transmits beacon signals 600 intermittently. Although not shown in FIG. 5, the PLC modem 1 keeps sending out the beacon signal throughout the ensuing communication.

Upon receipt of a beacon signal, the PLC modem 2 returns an entry signal 601 to the PLC modem 1. The PLC modem 1 in turn sends an enable signal 602 which is received by the PLC modem 2. The PLC modem 3 performs the same slave sequence as that of the PLC modem 2 as indicated by reference numerals 603 and 604.

With the above sequences completed, communication can take place at any time between the configured modems on a connectionless basis. That is, the PLC modems 1, 2 and 3 can communicate with one another on a carrier sense multiple access with collision avoidance (CSMA/CA) network 605.

It should be noted that the PLC modems 2 and 3 serving as slaves must keep on receiving the beacon signals from the PLC modem 1 acting as the master.

In the communication procedure shown in FIG. 5, data is transmitted on a best-effort basis. For applications such as streaming schemes that require high quality of service (QoS), data communication intervals are placed under concentrated control of the PLC modem 1 acting as the master.

In the foregoing description, the PDA 205 equipped with a PLC modem and a coil for electromagnetic coupling was shown to participate in the PLC network through the intervention of the coupling device such as the dedicated electromagnetic coupling sheet 202. However, unlike ordinary wired communication networks that utilize coaxial cables resistant to signal leakage, the PLC setup entails some signals leaking from a number of spots along the power line. The inventors of the present application think it possible to take advantage of such leakage signals from the power line within the framework of signal transmission and reception by use of the electromagnetic coupling effect occurring between the coil and the power line. The PDA 205 can thus take part in the PLC network for communication using such leakage signals.

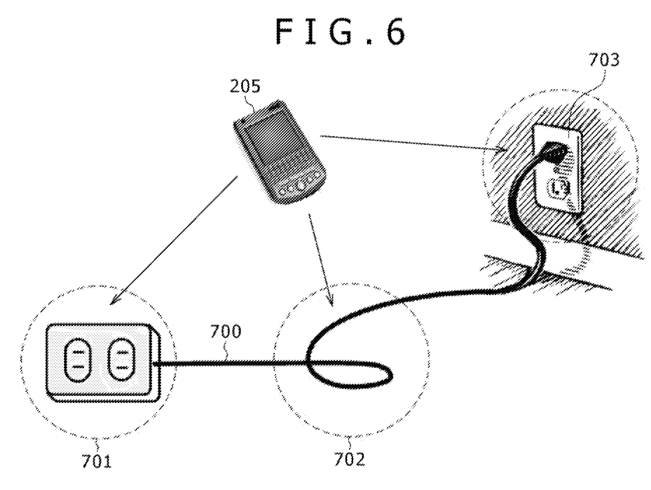

FIG. 6 is a schematic view showing a typical setup where the PDA 205 conducts communication using leakage power from the power line without recourse to the dedicated electromagnetic coupling sheet 202. In FIG. 6, reference numeral 700 stands for a power strip; 701 for an outlet part of the power strip; 702 for a cable part of the power strip; and 703 for a wall outlet. A PLC signal leaks from those parts designated by reference numerals 701 through 703. Bringing the PDA 205 close to or in contact with any one of such signal-leaking parts allows the device to conduct PLC-based data exchanges.

The leakage power from the parts above is at lower levels than that from the dedicated electromagnetic coupling sheet 202. That means throughput can be reduced correspondingly. Still, in the inventors' view, the method of communication illustrated in FIG. 6 can bring about significant advantages given that the dedicated sheet is not needed.

FIG. 7 schematically shows how mobile devices communicate with each other without the intervention of power line communication channels. Two PDAs (PDA 205, PDA 800) placed on the electromagnetic coupling sheet 202 communicate with each other using their respective electromagnetic connections to the coupling sheet 202.

There are cases where two PDAs acting as two slaves can communicate with each other without the need for beacon signals from the master PLC modem 103. In such cases, the electromagnetic coupling sheet 202 is not needed; the two PDAs need only be brought close to each other.

Although the description above contains many specificities, these should not be construed as limiting the scope of the present application but as merely providing illustrations of some of the presently preferred embodiments of this present application. It is to be understood that changes and variations may be made by those skilled in the art without departing from the spirit or scope of the claims that follow.

The foregoing description described the mobile device and the electromagnetic coupling sheet to be connected with one another through a magnetic field occurring therebetween. However, an electric field is also considered to play a significant role in the connection. Thus the present application is not limited by the effect of electromagnetic coupling.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A communication system comprising:
at least one power line communication device configured to be connected with another power line communication device via a common power line for providing a commercial alternate-current power supply; and
a communication terminal configured to include
a modem for power line communication, and
a coil for exchanging power line communication signals with an external entity through electromagnetic coupling,
said communication terminal sending and receiving the signals to and from said external entity through electromagnetic coupling between said coil and the power line.

2. A communication system comprising:
at least one power line communication device configured to be connected with another power line communication device via a common power line for providing a commercial alternate-current power supply;
a communication terminal configured to include
a modem for power line communication, and
a first coil for exchanging power line communication signals with an external entity through electromagnetic coupling; and
a coupling device configured to be connected with the power line and include
a filter for attenuating alternate-current components on said power line, and
a second coil installed upstream of said filter;
wherein said communication terminal conducts proximity communication with another communication terminal using the magnetic coupling effect occurring between said first and said second coils in the proximity of said coupling device.

3. A communication system comprising:
a plurality of communication terminals each configured to include
a modem for power line communication, and
a first coil for exchanging power line communication signals with an external entity through electromagnetic coupling; and
a coupling device configured to be connected with a power line and include
a plurality of second coils laid out in a two-dimensional array connected to said power line via a filter for attenuating alternate-current components on said power line;
wherein said plurality of communication terminals conduct proximity communication with one another using the magnetic coupling effect occurring between each of said first coils and each of said second coils in the proximity of said coupling device.

4. A communication system comprising:
a first and a second communication apparatus each configured to include
a modem for power line communication, and
a coil for exchanging power line communication signals with an external entity through electromagnetic coupling;
wherein said first and said second communication apparatuses conduct proximity communication with each other using the electromagnetic coupling effect occurring when the coil of said first communication apparatus is placed in proximity to the coil of said second communication apparatus in such a manner that the coils are opposed to each other.

5. A communication apparatus for use with the communication system claimed in claim 1, said communication apparatus comprising:
a modem for power line communication; and
a coil for exchanging power line communication signals with an external entity through electromagnetic coupling;
said communication apparatus further serving as said communication terminal in said communication system and participating in power line communication.

6. A communication apparatus for use with the communication system claimed in claim 2, said communication apparatus comprising:
a modem for power line communication; and
a coil for exchanging power line communication signals with an external entity through electromagnetic coupling;
said communication apparatus further serving as said communication terminal in said communication system and participating in power line communication.

7. A communication apparatus for use with the communication system claimed in claim 3, said communication apparatus comprising:
a modem for power line communication; and
a coil for exchanging power line communication signals with an external entity through electromagnetic coupling;
said communication apparatus further serving as said communication terminal in said communication system and participating in power line communication.

8. A communication apparatus for use with the communication system claimed in claim 2, said communication apparatus comprising:
connection means for being connected with a power line;
a filter configured to attenuate alternate-current components on said power line; and
a coil configured to be installed downstream of said filter;
wherein said communication apparatus serves as said coupling device in said communication system.

9. The communication apparatus according to claim 8, wherein said filter is a high-pass filter for cutting alternate-current components at 50 through 60 Hz.

10. The communication apparatus according to claim 8, wherein said filter is a high-pass filter constituted by a power transformer of which one end is connected to said coil and of which the other end is connected to said power line via a pair of capacitors.

11. The communication apparatus according to claim 8, further comprising
a plurality of second coils laid out in a two-dimensional array connected to said power line via a filter for attenuating alternate-current components on said power line.
